(19) United States
(12) Patent Application Publication
(10) Pub. No.: US 2006/0092863 A1
(43) Pub. Date: May 4, 2006

(54) Device and method for the computer-aided management of a telecommunication conference

(75) Inventors: Holger Schmidt, Braunschweig (DE); Norbert Schwagmann, Lehe (DE); Andreas Schmidt, Braunschweig (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/261,453

(22) Filed: Oct. 27, 2005

(30) Foreign Application Priority Data
Oct. 28, 2004 (DE) 10 2004 052 440.8

(51) Int. Cl. G06F 15/16

(52) U.S. Cl. 370/260; 709/227

(57) ABSTRACT

In the event of a request to terminate a telecommunication conference, a conference rule file is used to check whether the participant is authorized to terminate the conference. If authorization exists, the conference is terminated.

### CROSS-REFERENCE TO RELATED APPLICATION

This application claims priority to German Patent Application Serial No. 10 2004 052 440.8-42, which was filed on Oct. 28, 2004 and is incorporated herein by reference in its entirety.

### FIELD OF THE INVENTION

The invention relates to methods for the computer-aided management of a telecommunication conference and to telecommunication conference server devices.

### BACKGROUND OF THE INVENTION

Within the “work item” “IMS Stage-2 Enhancements” (TSG SA WD2/TSG CN WD1), the 3rd Generation Partnership Project (3GPP) currently specifies a multimedia telecommunication conference system for the Internet Protocol Multimedia Subsystem (IMS) of the Universal Mobile Telecommunication System (UMTS).

This telecommunication conference system is based on the architecture and the communication protocol components which have been described in the framework (Conferencing Framework) defined by the Internet Engineering Task Force (IETF) for this purpose (cf. J. Rosenberg, A framework for conferencing with the session initiation protocol, SIP Internet-Draft, IETF SIPPING working group: Draft-IETF-SIPPING-conferencing-framework-02, June 2004).

Besides a method for controlling the access rights to multimedia telecommunication conference resources (also called floor control) and for establishing conference rules (also called conference policy control), the telecommunication conference system also provides Session Initiation Protocol (SIP)-based procedures, inter alia for generating, for managing, for entering and for leaving telecommunication conferences. In addition, this system also includes methods for notifying the conference participants (also called conference notification service) about specific information and events concerning the telecommunication conference. Within the telecommunication conference system, it is possible to interchange any types of media between the participants, and for this reason it is also called a multimedia telecommunication conference system below.

To terminate a multimedia telecommunication conference which has been set up, J. Rosenberg, and 3rd Generation Partnership Project, Technical Specification Group Core Network, Conferencing Using the IP Multimedia (IM) Core Network (CN) Subsystem, Stage 3 (Release 6), 3GPP TS 24.147 V6.0.0, September 2004 disclose the practice of terminating the conference when the last participant in the conference leaves the telecommunication conference.

Alternatively, 3rd Generation Partnership Project, Technical Specification Group Core Network, Conferencing Using the IP Multimedia (IM) Core Network (CN) Subsystem, Stage 3 (Release 6), 3GPP TS 24.147 V6.0.0, September 2004, and A. Johnston et al., Session Initiation Protocol Call Control—Conferencing for user agents, SIPPING Working Group, Internet Draft, IETF SIPPING Working Group: Draft-IETF-SIPPING-CC-Conferencing-04, July 2004, disclose the practice of terminating a conference when the participant who initiated the multimedia telecommunication conference leaves the conference.

In line with H. Khartabil et al., The Conference Policy Control Protocol (CPCP), XCON, Internet Draft, IETF XCON Working Group: Draft IETF-XCON-CPCP-XCAP-01, July 2004, only that participant who generated the telecommunication conference is able to terminate the conference explicitly by deleting the conference policy. H. Khartabil et al. describes the so-called “Conference Policy Control Protocol” (CPCP), which provides the opportunity to define different rules during such a multimedia telecommunication conference. An example of a conference policy file (conference policy document) in Extensible Markup Language format (XML format), as described in H. Khartabil et al., is shown below by way of example.

Conference rule file example 1

```
<?xml version=“1.0” encoding=“UTF-8”?>
<conference xmlns=“urn:ietf:params:xml:ns:conference-policy”
xmlns:xsi=“http://www.w3.org/2001/XMLSchema-instance”>
  <settings>
    <conference-
  uri>sip:myconference@example.com</conference-uri>
  <max-participant-count>10</max-participant-count>
  <allow-sidebars>true</allow-sidebars>
  </settings>
  <info xml:lang=“en-us”>
    <subject>What's happening tonight</subject>
    <display-name>Party Goer's</display-name>
  <free-text>John and Peter will join the conference
soon</free-text>
  <keywords>party nightclub beer</keywords>
  <host-info>
    <uri>sip:Alice@example.com</uri>
    <uri>tel:+3581234567</uri>
    <e-mail>mailto:Alice@example.com</e-mail>
    <web-
  page>http://www.example.com/users/Alice</web-page>
  </host-info>
</info>
<time>
  <occurrence>
    <mixing-start-time required-
  participant=“participant”>2004-12-17T09:30:00-
  05:00</mixing-start-time>
    <mixing-stop-time required-
  participant=“none”>2004-12-17T12:30:00-
  05:00</mixing-stop-time>
    <can-join-after>2001-12-17T09:25:00-05:00</can-
    join-after>
    <must-join-before>2004-12-17T12:00:00-
  05:00</must-join-before>
    <request-users required-
  participant=“none”>2001-12-17T09:30:00-
  05:00</request-users>
  </occurrence>
</time>
<authorization-rules>
  <rule id=“1”>
    <conditions>
      <identity>
        <domain>example.com</domain>
      </identity>
    </conditions>
    <actions>
      <allow-conference-state>true</allow-
    conference-state>
        <join-handling>allow</join-handling>
      </actions>
      <transformations/>
    </rule>
    <rule id=“2”>
      <conditions>
        <identity>
          <id>alice@example.com</id>
        </identity>
      </conditions>
      <actions>
        <allow-sidebar>true</allow-sidebar>
      </actions>
      <transformations>
        <is-key-participant>true</is-key-
      participant>
      </transformations>
    </rule>
  </authorization-rules>
  <dialout-list>
    <target uri=“sip:bob@example.com”/>
  </dialout-list>
  <refer-list >
    <target uri=“sip:sarah@example.com”/>
  </refer-list >
  <security-control>
    <security-mechanism tls=“false” s-mime=“true”/>
    <pin>13579</pin>
    <password>abcd1234</password>
  </security-control>
  <floor-policy>
    <floor floor-control=“fcp://example.com/floorabc”
  moderator-controlled=“false”>
      <media-streams>
        <audio media-id=“2”/>
      </media-streams>
      <algorithm>
        <fcfs/>
      </algorithm>
      <max-floor-users>1</max-floor-users>
    </floor>
  </floor-policy>
  <media-streams>
    <video media-id=“1”/>
    <audio media-id=“2”/>
  </media-streams>
</conference>
```

Requests for Comments (RFC) 3261, SIP: Session Initiation Protocol describes the Session Initiation Protocol (SIP).

J. Rosenberg describes the “Extensible Markup Language Configuration Access Protocol” (XCAP).

On account of the above-described inflexibility in terminating a conference, considerable difficulties may arise for the participants in a multimedia telecommunication conference, for example unintentional termination of a telecommunication conference as a result of the participant who generated the conference leaving the telecommunication conference, even though this is not intended between the other participants in the telecommunication conference and possibly even by the participant who generated the conference.

WO 98/56177 describes a system for dynamically selecting media streams.

In addition, WO 03/005689 A1 discloses the practice of associating a conference identification indicator clearly identifying the conference with a telecommunication conference in the mobile radio sector.

US 2003/0050060 A1 describes a communication architecture using local satellite processors.

In addition, US 2003/0224722 A1 discloses a method for providing network-based wireless services.

WO 99/62272 A1 describes a system for assisting in the provision of communication services which supports several different types of services during a service session, the system having a unit for managing the sessions (Session Manager).

WO 2004/049625 A1 , WO 97/09815 A1 , EP 1 372 328 A1 , and EP 0 713 319 A2 describe methods and apparatuses for automatically setting up conference connections.

EP 1 414 227 A1 describes a device which is used to identify a prescribed event in a voice channel in a communication system which has a plurality of voice channels.

EP 1 465 397 A1 describes a method and an apparatus which are used for the voice-based management of the status and the interaction of a “knowledge worker” in a contact center environment.

DE 102 38 285 A1 discloses a method and an apparatus for providing conferences, where a control interface is provided between an announcement/dialogue function with voice recognition functionality and a conference management function which can be used to initiate the conference and to control it while it is running.

DE 696 31 687 T2 discloses a method for providing and a system for performing a conference service in a telecommunication network, where the telecommunication network covers a number of switching systems among which one or more has one or more conference bridges.

US 2003/0174826 A1 discloses a video conference system which has a plurality of participant stations at each of a plurality of locations and also a pilot station, with a conference leader receiving a notification from the pilot station if a participant station is no longer available at a location, and routing the conference participants to another available participant station.

The invention is based on the problem of flexibly defining and altering rights or events which can be taken as a basis for stopping or terminating a telecommunication conference in simple fashion.

### SUMMARY OF THE INVENTION

An apparatus and method for the computer-aided management of a telecommunication conference using a telecommunication conference server device which provides at least one telecommunication conference between a plurality of participants, where the telecommunication conference server device has access to an electronic telecommunication conference rule file, with the telecommunication conference rule file containing, for the telecommunication conference provided, information which can be used to ascertain that participant or those participants who is/are permitted to stop or terminate the telecommunication conference or to stop part of the telecommunication conference. The telecommunication conference server device receives a request from a participant participating in the telecommunication conference to stop or terminate the telecommunication conference or to stop part of the telecommunication conference. The telecommunication conference server device uses the telecommunication conference rule file to check whether the participant is authorized to stop or terminate the telecommunication conference or to stop part of the telecommunication conference. If the participant is not authorized to stop or terminate the telecommunication conference or to stop the part of the telecommunication conference then the telecommunication conference server device continuing the telecommunication conference. If the participant is authorized to stop or terminate the telecommunication conference or to stop the part of the telecommunication conference then the telecommunication conference server device stopping or terminating the telecommunication conference or stopping the part of the telecommunication conference.

### BRIEF DESCRIPTION OF THE DRAWINGS

Exemplary embodiments of the invention are illustrated in the figures and are explained in more detail below.

FIG. 1 shows a telecommunication conference system, particularly a mobile radio telecommunication conference system, based on the preferred exemplary embodiments of the invention;

FIG. 2 shows a message flow diagram illustrating the termination of a telecommunication conference based on a first exemplary embodiment of the invention;

FIG. 3 shows a message flow diagram illustrating the changing of termination rights based on a first exemplary embodiment of the invention;

FIG. 4 shows a message flow diagram illustrating the changing of termination rights based on a second exemplary embodiment of the invention; and

FIG. 5 shows a message flow diagram illustrating the termination of a telecommunication conference based on a third exemplary embodiment of the invention.

### DETAILED DESCRIPTION OF PREFERRED EMBODIMENTS OF THE INVENTION

The problem is solved by the methods for the computer-aided management of a telecommunication conference and also by telecommunication conference server devices.

In a method for the computer-aided management of a telecommunication conference using a telecommunication conference server device which provides at least one telecommunication conference between a plurality of participants, the telecommunication conference server device receives a request from a participant participating in the telecommunication conference, with the request being used to request that the telecommunication conference be stopped or terminated or that part of the telecommunication conference be stopped. The telecommunication conference server device has access to an electronic telecommunication conference rule file (also called conference policy document). In comparison with the prior art, the telecommunication conference rule file additionally contains, for the telecommunication conference provided, information which can be used to ascertain which participant or which participants is/are permitted to stop or terminate the telecommunication conference or to stop the part of the telecommunication conference. Following receipt of the request, the telecommunication conference server device uses the telecommunication conference rule file to check whether the participant sending the request and hence normally the participant making the request is authorized to stop or terminate the telecommunication conference or to stop the part of the telecommunication conference. If the participant is not authorized to stop or terminate the telecommunication conference or to stop the part of the telecommunication conference then the telecommunication conference server device will continue the participant communication conference and may inform the participant about the lack of authorization and hence the nonprovision of the requested service, for example using an appropriate negative confirmation message (Negative Acknowledgement NACK) which is transmitted to the participant. If the participant is authorized to stop or terminate the telecommunication conference or to stop the part of the telecommunication conference then the telecommunication conference server device stops or terminates the telecommunication conference or stops the part of the telecommunication conference.

In line with an alternative aspect of the invention, a method for the computer-aided management of a telecommunication conference using a telecommunication conference server device is provided in which the telecommunication conference server device provides at least one telecommunication conference between a plurality of participants. The telecommunication conference server device has access to an electronic telecommunication conference rule file (conference policy document) which contains, for the telecommunication conference provided, information which can be used to ascertain what event or what events are intended to be taken as a basis for stopping or terminating the telecommunication conference or for stopping a part of the telecommunication conference. The telecommunication conference server device uses the telecommunication conference rule file to check whether the event has occurred or whether the events have occurred. If the event or the events has/have not occurred then the telecommunication conference or the part of the telecommunication conference is continued unchanged by the telecommunication conference server device. If the event or the events indicated in the telecommunication conference rule file has/have occurred then the telecommunication conference server device stops or terminates the telecommunication conference or stops the part of the telecommunication conference, according to specification, as stored in the telecommunication conference rule file.

It should be noted that the methods above may also be used in combination with one another, i.e. the telecommunication conference rule file may store both the participant or participants authorized to stop or terminate a telecommunication conference or to stop a part of a telecommunication conference and the event or events intended to result in a telecommunication conference being stopped or terminated or in a part of a telecommunication conference being stopped, and either at the request of a participant or continuously the telecommunication conference server device is able to check the telecommunication conference rule file for the rights of the participant to determine whether an event indicated in the telecommunication conference rule file has occurred.

A telecommunication conference server device is set up to provide at least one telecommunication conference between a plurality of participants. The telecommunication conference server device has access to an electronic telecommunication conference rule file, the telecommunication conference rule file containing, for the telecommunication conference provided, information which can be used to ascertain which participant or which participants is/are permitted to stop or terminate the telecommunication conference or to stop part of the telecommunication conference. In addition, there is a receiving unit for receiving a request from a participant participating in the telecommunication conference to stop or terminate the telecommunication conference or to stop the part of the telecommunication conference. There is also an authorization checking unit for checking, using the telecommunication conference rule file, whether the participant is authorized to stop or terminate the telecommunication conference or to stop the part of the telecommunication conference. In addition, there is a telecommunication conference termination unit which is set up to stop or terminate the telecommunication conference or to stop the part of the telecommunication conference if the participant is authorized to stop or terminate the telecommunication conference.

A telecommunication conference server device based on another aspect of the invention is likewise set up to provide at least one telecommunication conference between a plurality of participants. The telecommunication conference server device has access to an electronic telecommunication conference rule file, the telecommunication conference rule file containing, for the telecommunication conference provided, information which can be used to ascertain what event or what events are to be taken as a basis for stopping or terminating the telecommunication conference or for stopping part of the telecommunication conference. In addition, the telecommunication conference server device contains an event checking unit for checking, using the telecommunication conference rule file, whether the event or the events has/have occurred. There is also a telecommunication conference termination unit which is set up to stop or terminate the telecommunication conference or to stop the part of the telecommunication conference if the event or the events has/have occurred.

In an alternative embodiment of the invention, the telecommunication conference server device has both an authorization checking unit, as described above, and an event checking unit as described above. In this case, the telecommunication conference termination unit is set up to stop or terminate the telecommunication conference or to stop the part of the telecommunication conference if either the participant requesting termination or stopping of the telecommunication conference is authorized to make this request when an appropriate request has been received or an event or events contained in the telecommunication conference rule file has/have occurred which is/are intended to result in the telecommunication conference being stopped or terminated or in the part of the telecommunication conference being stopped.

Clearly, the invention can be seen in that appropriate entries in the telecommunication conference rule file now provide a flexible way of prescribing different rules regarding the situation or who is able to terminate or stop a conference or to stop part of the telecommunication conference.

This results in a very simple way, which can nevertheless be adjusted in as much detail as desired, of developing rules for terminating or stopping a telecommunication conference or for stopping part of the telecommunication conference and incorporating them into a telecommunication conference architecture.

Clearly, the conference policy, particularly the conference policy document, i.e. the telecommunication conference rule file, is thus extended by different details, in line with one aspect of the invention by a detail indicating one or more participants who are authorized to terminate or stop a conference or to stop part of a conference, in line with another aspect by details of one or more events whose occurrence is to be taken as a basis for stopping or terminating a conference or stopping part of a conference.

In this connection, it should be pointed out that in line with the invention a participant is to be understood to mean both a telecommunication appliance, preferably a telecommunication terminal, particularly preferably a mobile radio telecommunication terminal, currently participating in the telecommunication conference and a user of a telecommunication appliance who is participating in the telecommunication conference and is clearly identifiable therein, or alternatively a telecommunication appliance or user thereof which/who, although not currently participating in the telecommunication conference, is granted the appropriate rights.

Unlike in the prior art, it is now possible for the first time to stipulate, within a telecommunication conference system, those events which can be taken as a basis for terminating or stopping a telecommunication conference or for stopping part of a telecommunication conference.

The inventive refinements described below relate both to the methods for the computer-aided management of a telecommunication conference and to the telecommunication conference server devices.

The functionality of the respective method steps or of the units described can be implemented either in hardware, i.e. using special electronic circuits, in software, i.e. using special computer programs, or in arbitrarily hybrid form, i.e. with their component functionalities split arbitrarily into hardware and software.

In line with one refinement of the invention, the telecommunication conference rule file can be altered by one or more participants in the telecommunication conference.

This provides a very simple flexible way of extending and changing the rights which authorize termination or stopping of the telecommunication conference or the events which result in the telecommunication conference being terminated or stopped or in part of the telecommunication conference being stopped.

The telecommunication conference rule file may preferably contain information indicating which participant or which participants is/are permitted to alter the telecommunication conference rule file. If the telecommunication conference rule file contains information regarding what event or what events result in the telecommunication conference being terminated or stopped or in part of the telecommunication conference being stopped then one refinement of the invention has provision for the telecommunication conference rule file to contain information indicating which participant or which participants is/are permitted to alter the telecommunication conference rule file.

In particular, the telecommunication conference rule file contains information indicating which participant or which participants is/are permitted to alter, in the telecommunication conference rule file, the information which can be used to ascertain which participant or which participants is/are permitted to stop or terminate the telecommunication conference or to stop part of the telecommunication conference.

Clearly, this means that an entry in the telecommunication conference rule file flexibly and easily grants changeable rights, possibly to a plurality of participants, to grant or alter the termination or stopping rights for the telecommunication conference or the stopping rights for part of the telecommunication conference.

Correspondingly, in another refinement of the invention, provision may be made for the telecommunication conference rule file to contain information regarding which participant or which participants is/are permitted to alter, in the telecommunication conference rule file, the information which can be used to ascertain what event or what events are taken as a basis for stopping or terminating the telecommunication conference or for stopping part of the telecommunication conference.

This refinement results in corresponding advantages as described above for the indication of the participants who are permitted to alter the rights for terminating or stopping a telecommunication conference.

In line with one refinement of the invention, the information regarding which participant is authorized to stop or terminate the telecommunication conference or to stop part of the telecommunication conference is stored in the telecommunication conference rule file in the form of one or more authorization data elements, preferably in Extensible Markup Language format (XML format).

The information regarding which participant is authorized to stop or terminate the telecommunication conference or to stop part of the telecommunication conference may, in one alternative refinement of the invention, be stored in the telecommunication conference rule file in the form of one or more action data elements. The use of data elements to define the respective participants provides a very clear and structured way of finding, editing and evaluating this information.

An event contained in the telecommunication conference rule file may be one of the following events:
one or more participant(s) in the telecommunication conference which is/are indicated in the telecommunication conference rule file leaves or leave the telecommunication conference,
a time indicated in the telecommunication conference rule file is reached and/or
the telecommunication conference has already existed for a maximum period indicated in the telecommunication conference rule file.

The communication taking place between the participants and the telecommunication conference server device is preferably at least partly based on the Session Initiation Protocol (SIP), which is described in Requests for Comments (RFC) 3261, SIP: Session Initiation Protocol.

In line with another refinement of the invention, the communication taking place between the participants and the telecommunication conference server device is at least partly based on the Conference Policy Control Protocol (CPCP), as described in H. Khartabil et al., The Conference Policy Control Protocol (CPCP), XCON, Internet Draft, IETF XCON Working Group: Draft IETF-XCON-CPCP-XCAP-01, July 2004, particularly for creating or altering the conference policy, and hence particularly for creating or altering the telecommunication conference rule file.

In line with one refinement of the invention, the telecommunication conference server device provides a multimedia telecommunication conference in which the participants are provided with a plurality of different media data streams, for example audio data streams, video data streams, text data streams etc.

In line with this refinement of the invention, a telecommunication conference which is flexible in terms of the medium to be used and which is therefore convenient for the participants is provided.

The telecommunication conference server device is preferably clearly identifiable by means of an SIP Unique Resource Identifier (URI), this identifier being associated with a telecommunication conference preferably when the latter is generated and being released again when the telecommunication conference has been terminated, so that-it can be associated with another, subsequently generated telecommunication conference again. In particular, the corresponding conference identification is also called a conference URI (C-URI) according to J. Rosenberg.

The telecommunication conference rule file is particularly preferably stored on the basis of the Extensible Markup Language Format (XML format), which achieves a standardized, simple and inexpensive representation of the file.

The telecommunication conference rule file is preferably read and written and changed on the basis of the Hypertext Transport Protocol (HTTP), in other words the telecommunication conference rule file is preferably accessed using HTTP. This has the particular advantage that standardized protocols can be used for accessing this file, which means that existing systems do not need to be altered for file access operations.

The participants in the telecommunication conference transmit and/or receive data preferably using a mobile radio system, particularly preferably on the basis of a 3GPP mobile radio system, particularly preferably on the basis of UMTS. In other words, this means that the telecommunication conference server device is preferably set up to communicate using a mobile radio system, in this instance particularly preferably on the basis of a 3GPP mobile radio system and in this instance particularly preferably on the basis of UMTS.

The invention is thus particularly suitable for use in a, preferably cell-based, mobile radio communication system. In other words, this means that the telecommunication conference server device is thus preferably a component part of a mobile radio communication system, particularly preferably of a 3GPP mobile radio communication system and in this instance particularly preferably of the “IP Multimedia Core Network Subsystem” (IMS) of the UMTS mobile radio communication system.

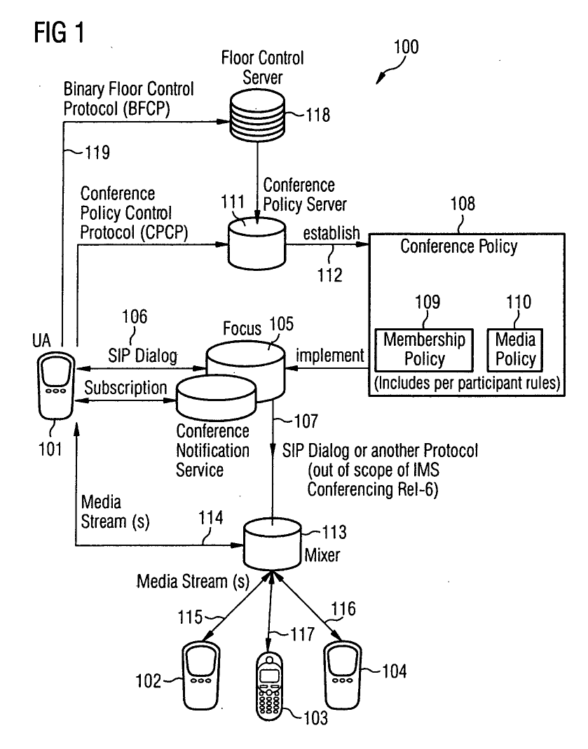

FIG. 1 shows a mobile radio multimedia telecommunication conference system 100 based on the preferred exemplary embodiments of the invention. It should be pointed out that in one alternative refinement it does not have to be a mobile radio multimedia telecommunication conference system. The methods described below and above may also be implemented in a landline multimedia telecommunication conference system, for example an internet-based landline multimedia telecommunication conference system. In this alternative embodiment, at least some of the telecommunication terminals are set up as landline telecommunication terminals which are set up particularly for implementing an internet-based telecommunication conference.

The system 100 is identical for all the exemplary embodiments which are explained in more detail below apart from the different refinements of the focus server, which is respectively set up such that it has implemented the functionalities of the respective exemplary embodiments.

The individual units described below can each be implemented in individual separate hardware units, for example standalone computer or mobile radio terminals, or at least partly in software, i.e. using computer programs which are implemented in separate or in joint computer units.

Apart from the changes described below, the communication system is in a form based on the embodiments of the invention, as described in J. Rosenberg.

The “conferencing framework” described in J. Rosenberg and illustrated in FIG. 1 provides the users, particularly the mobile radio terminals 101, 102, 103, 104, with different multimedia telecommunication conference services. In particular, as described in detail in J. Rosenberg, a service for controlling the access rights to telecommunication conference resources, also called floor control, a service for establishing conference rules (which are also called conference policy control), and also, in the form of procedures based on the Session Initiation Protocol (SIP), additional services for generating, managing, entering and leaving multimedia telecommunication conferences are provided.

In addition, the communication system 100, as likewise described in J. Rosenberg, provides methods for notifying the conference participants 101, 102, 103, 104, also called conference notification service, about specific information and events relating to a respective multimedia telecommunication conference.

The conference system 100 is set up such that any media types can be interchanged between the participants, i.e. between the mobile radio terminals 101, 102, 103, 104. Examples of a media type which can be transmitted and processed within the conference system 100 are audio data, video data, instant messaging data and data from multiplayer games within the context of a gaming conference.

FIG. 1 shows, as described above, the multimedia telecommunication conference system 100 based on the exemplary embodiments of the invention with its individual components and the interaction between the components.

The multimedia telecommunication conference system 100 has a star-shaped conference architecture in which all the conference participants (also called user agents), which are mobile radio terminals 101, 102, 103, 104 in these exemplary embodiments, are connected to the conference server device 105, also called focus 105, by means of SIP signalling link 106. However, FIG. 1 shows just one of these SIP signalling links, 106, by way of example.

A respective particular mobile radio telecommunication conference, which is associated with a particular conference server computer 105, i.e. with a particular focus, or is executed thereon, has a unique conference address associated with it, the “conference-unique resource identifier” (C-URI). The C-URI represents and addresses the respective conference uniquely. The focus 105 has indirect access, inter alia, to the conference policy. The conference policy file, subsequently also called conference rule file 108, is usually logically made up of two subregions, a membership policy 109 and a media policy 110. Under some circumstances, the conference policy file may be stored physically split over a plurality of subfiles, however. Besides the physical separation, the conference policy file may in this context also be split logically. The conference rule file 108 is generated exclusively for a respective conference by a conference rule server (conference policy server) 111, symbolized in FIG. 1 by an arrow 112. The focus 105 is informed about the content and any change in the conference policy file via the conference rule server. It is also conceivable for the focus 105 to have direct access to the conference policy file.

In addition to converting these conference rules stored in the conference rule file 108, the focus 105 has the task of ensuring conference-specific distribution of the media data streams.

To distribute the media data streams, the focus 105 uses “mixers” 113, in other words data stream mixing devices, which use the media rules stored in the media policy 110 to carry out the individual compilation and to distribute the media data streams over the mobile radio terminals 101, 102, 103, 104 participating in the conference, symbolized in FIG. 1 by means of double-headed arrows 114, 115, 116, 117. The mobile radio terminals 101, 102, 103, 104 have a few additional procedures, communication protocols and functionalities implemented in them for the purpose of providing the conference service, in particular there are new additional SIP procedures implemented and also the “Binary Floor Control Protocol” (BFCP), implemented on the server in a floor control server 118, and the Conference Policy Control Protocol (CPCP) or the respective units which are able to execute the appropriate communication protocols. The Binary Floor Control Protocol communication link between a first mobile radio terminal 101 and the floor control server 118 is symbolized by an arrow 119 in FIG. 1.

Hence, every detail of these procedures and protocols is significant for the mobile radio terminal (mobile terminal) 101, 102, 103, 104 and hence for the hardware and/or software used in the terminal.

The Conference Policy Control Protocol (CPCP) described in H. Khartabil et al. affords the opportunity to define different rules for a multimedia telecommunication conference. Thus, by way of example, general conference rules, such as the maximum number of conference participants, can be indicated within the conference rule file (conference policy) using the CPCP. The conference rule file also contains a “dial-out” list (<dial-out-list> data element), for example, which indicates which users or which telecommunication terminals are to be invited to join a conference when the latter is activated.

The conference policy also contains authorization data elements which are used to indicate which user is permitted to enter other users into the “dial-out” list (<allow-modify-dol> data element).

To stipulate who is permitted to edit authorization data elements, the CPCP provides a superordinate authorization data element which regulates the access to all the other authorization data elements (<allow-modify-authorization-rules> data element).

The conference rule file is specified in the form of at least one XML document (Extensible Markup Language file). On account of the use of XML to describe the conference rule file 108, it is possible to extend, generally to change, the conference rule file in a simple manner.

To transmit the XML files, i.e. particularly the conference rule file 108, or to read data from the conference rule file and/or to write data to the conference rule file 108, the Hypertext Transport Protocol (HTTP) is used.

A conference rule file 108 is written, or information is written in a conference rule file 108, using an HTTP Put Request, whereas a conference rule file 108 or part of a conference rule file 108 is read using an HTTP Get Request and an entire conference rule file 108 or part of the conference rule file 108 is deleted using an HTTP Delete Request.

The CPCP also allows individual elements, attributes or attribute values of an XML document and hence of the conference rule file 108 based on this exemplary embodiment of the invention to be addressed using the HTTP Unique Resource Locator (HTTP URL).

The text below gives a more detailed explanation of the design of a conference rule file 108 in XML, the basic structure of such a conference rule file 108 being known from H. Khartabil et al. and also being designed in this way.

The conference rule file 108 describes the conference rules.

The conference rule file 108 has different data elements, for example the <info> data element, which contains general free-text information relating to the respective multimedia telecommunication conference, the <settings> data element, which indicates, inter alia, the conference address (<conference-uri> sub data element) and the maximum number of conference participants (<max-participants-count> sub data element), the <authorization-rules> data element, which contains the individual authorization data elements, and also, by way of example, the <dial-out-list> data element, which lists the participants who are to be invited to join the respective conference.

The text below shows a conference rule file 108 based on a first exemplary embodiment of the invention in XML format:

Conference rule file example 2

```
<?xml version=“1.0” encoding=“UTF-8”?>
<conference xmlns=“urn:ietf:params:xml:ns:conference-policy”
xmlns:xsi=“http://www.w3.org/2001/XMLSchema-instance”>
  <settings>
    <conference-
  uri>sip:myconference@example.com</conference-uri>
    <max-participant-count>10</max-participant-count>
  <allow-sidebars>true</allow-sidebars>
</settings>
<info xml:lang=“en-us”>
  <subject>What's happening tonight</subject>
  <display-name>Party Goer's</display-name>
  <free-text>John and Peter will join the conference
soon</free-text>
  <keywords>party nightclub beer</keywords>
  <host-info>
    <uri>sip:Alice@example.com</uri>
    <uri>tel:+3581234567</uri>
    <e-mail>mailto:Alice@example.com</e-mail>
    <web-
  page>http://www.example.com/users/Alice</web-page>
  </host-info>
</info>
<time>
  <occurrence>
    <mixing-start-time required-
  participant=“participant”>2004-12-17T09:30:00-
  05:00</mixing-start-time>
    <mixing-stop-time required-
  participant=“none”>2004-12-17T12:30:00-
  05:00</mixing-stop-time>
    <can-join-after>2001-12-17T09:25:00-05:00</can-
  join-after>
    <must-join-before>2004-12-17T12:00:00-
  05:00</must-join-before>
    <request-users required-
  participant=“none”>2001-12-17T09:30:00-
  05:00</request-users>
  </occurrence>
</time>
<authorization-rules>
  <rule id=“1”>
    <conditions>
      <identity>
        <domain>example.com</domain>
      </identity>
    </conditions>
    <actions>
      <allow-conference-state>true</allow-
    conference-state>
      <join-handling>allow</join-handling>
    </actions>
    <transformations/>
  </rule>
  <rule id=“2”>
    <conditions>
      <identity>
        <id>alice@example.com</id>
      </identity>
    </conditions>
    <actions>
      <allow-sidebar>true</allow-sidebar>
    </actions>
    <transformations>
      <is-key-participant>true</is-key-
    participant>
    </transformations>
  </rule>
  <rule id=”3”>
    <conditions>
      <identity>
        <id>alice@example.com</id>
      </identity>
    </conditions>
    <actions>
      <allow-modify-tl>true</allow-modify-tl>
    </actions>
    <transformations/>
  </rule>
</authorization-rules>
<terminate-list>
  <target uri=”sip:alice@example.com”>
  <target uri=”sip:eckbertowitsch@example.com”>
    <target uri=”sip:schwagomilinski@ostfriesland.de”>
  </terminate-list>
  <dialout-list>
    <target uri=“sip:bob@example.com”/>
  </dialout-list>
  <refer-list >
    <target uri=“sip:sarah@example.com”/>
  </refer-list >
  <security-control>
    <security-mechanism tls=“false” s-mime=“true”/>
    <pin>13579</pin>
    <password>abcd1234</password>
  </security-control>
  <floor-policy>
    <floor floor-control=“fcp://example.com/floorabc”
  moderator-controlled=“false”>
      <media-streams>
        <audio media-id=“2”/>
      </media-streams>
      <algorithm>
        <fcfs/>
      </algorithm>
      <max-floor-users>1</max-floor-users>
    </floor>
  </floor-policy>
  <media-streams>
    <video media-id=“1”/>
    <audio media-id=“2”/>
  </media-streams>
</conference>
```

The example above is essentially based on the example described in the prior art (Conference rule file example 1), the changes made in this exemplary embodiment in comparison with the prior art having been highlighted by bold text and underlining.

In line with the first exemplary embodiment of the invention, the conference rule file 108 contains a new, additional conference rule data element (new conference policy element) which can be used to indicate which participant is authorized to terminate the respective existing conference:

```
<terminate-list>
  <target uri=”sip:alice@example.com”>
  <target uri=”sip:eckbertowitsch@example.com”>
  <target uri=”sip:schwagomilinski@ostfriesland.de”>
</terminate-list>
```

In this example, the participants “alice@example.com”, “eckbertowitsch@example.com” and “schwagomilinski@ostfriesland.de” are authorized to terminate the existing conference.

In this connection, it should be noted that for each activated and existing conference a conference rule file 108 is generated and provided which is deleted again when the respective conference is terminated.

In addition, an additional authorization data element is optionally described in “Conference rule file example 2” and is used to stipulate which participant can identify new participants as being authorized for termination:

```
<rule id=”3”>
  <conditions>
    <identity>
      <id>alice@example.com</id>
    </identity>
  </conditions>
  <actions>
    <allow-modify-tl>true</allow-modify-tl>
  </actions>
  <transformations/>
</rule>
```

In this example, the participant “alice@example.com” is authorized to change the termination authorizations, i.e. to authorize another participant to terminate a conference or to take this authorization away from another participant.

As described above, the conference rule data element called <terminate-list> in example 2 above thus contains three participants, who in this exemplary embodiment are indicated by means of their respective SIP-URIs, without limiting the general validity. In line with this exemplary embodiment of the invention, the three users are authorized to terminate the conference which has been generated. In this example, the generator of the conference, in this case called “Alice” (cf. “Conference rule file example 2”, <target uri=“sip:alice@example.com”>), is likewise shown in the <terminate-list> data element. Through reinterpretation of the <terminate-list>, this list can indicate which user is authorized to stop the multimedia telecommunication conference.

In one alternative refinement of the invention, however, provision is made for the generator(s) of a respective conference not to have to be entered separately in the list, i.e. in the <terminate-list> data element, but rather to be generally authorized, on the basis of a generally valid rule which is not shown separately, to terminate the respective conference which they have generated.

In this case, the <terminate-list> data element described here would contain only the participants (users) who are intended to be authorized to terminate or stop the conference in addition to the conference generator.

The conference rule server 111, which, as described in J. Rosenberg, 3rd Generation Partnership Project, Technical Specification Group Core Network, Conferencing Using the IP Multimedia (IM) Core Network (CN) Subsystem, Stage 3 (Release 6), 3GPP TS 24.147 V6.0.0, September 2004 and H. Khartabil et al., manages the conference rule file, will thus check (cf 3rd Generation Partnership Project, Technical Specification Group Core Network, Conferencing Using the IP Multimedia (IM) Core Network (CN) Subsystem, Stage 3 (Release 6), 3GPP TS 24.147 V6.0.0, September 2004), after receipt of an HTTP Delete message for terminating the conference, whether the request comes from a participant shown in the <terminate-list> data element.

In this connection, it should be pointed out that the expression user or participant is not limited to telecommunication appliances or users of the telecommunication appliances which are actually participating in the conference, but rather may include all the subscribers registered and licensed in the mobile radio network. In addition, it should be pointed out that the expression user or participant refers both to a respective telecommunication terminal, for example the mobile radio terminal 101, 102, 103, 104, or possibly the user of the respective telecommunication appliance.

If the request comes from a participant shown in the <terminate-list> data element then the conference rule server deletes the conference policy document, i.e. the conference rule file 108, and informs the conference server computer 105, i.e. the focus, that the conference has been terminated or that the conference has been stopped. If it has been terminated, the focus 105 terminates all the SIP sessions or dialogues associated with this conference, i.e. it removes all the conference participants, inter alia, from the conference and releases all the conference resources used again.

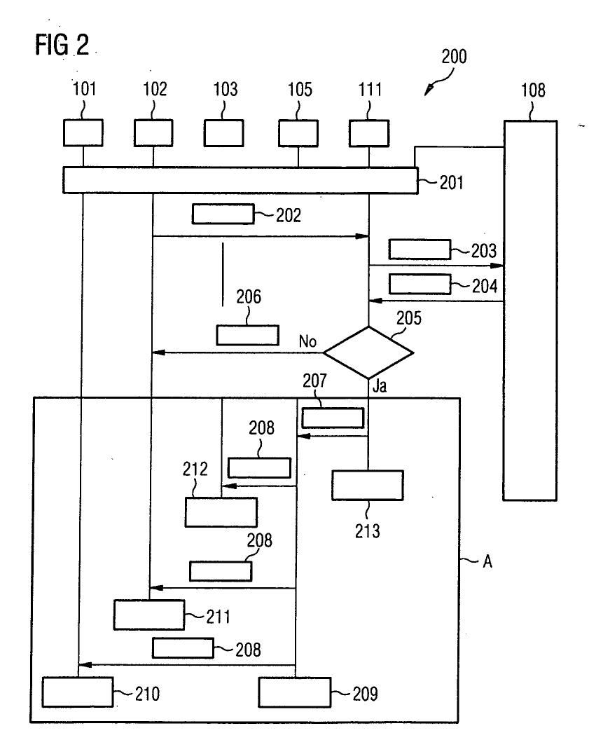

This procedure is shown again in a message flow diagram 200 in FIG. 2 and is explained in more detail below.

FIG. 2 shows, by way of example, three mobile radio terminals 101, 102, 103, the focus 105, the conference rule server 111 and the conference rule file 108. A block 201 in the message flow diagram 200 is used to provide a symbolic illustration that a conference organized and controlled by the focus 105 and the conference rule server 111 is activated and set up between the mobile radio terminals 101, 102, 103.

Hence, a conference rule file 108 storing the individual conference-related rights and additional information is also generated and stored for the conference.

In this exemplary embodiment, it is assumed that the second mobile radio terminal 102 transmits a termination request message 202 to the conference rule server 111, whereupon the latter reads, 203 and 204, the corresponding information in the stored conference rule file 108 to check whether the user, in this case the second mobile radio terminal 102, is authorized to terminate or stop the conference.

In other words, the conference rule server 111 checks whether the second mobile radio terminal 102 or its user is contained in the <terminate-list> data element in the conference rule file 108. When the conference rule file 108 has been checked by the conference rule server 111, symbolized in FIG. 2 by means of a <terminate-list> read message 203 and a <terminate-list> data element message 204 which contains the <terminate-list> data elements, the latter decides whether the participant sending the request is authorized to terminate or stop the conference (checking step 205).

If this is not the case then the conference rule server 111 generates and transmits a negative acknowledgement message 206 and transmits this message to the second mobile radio terminal 102 and hence to the participant requesting that the conference be terminated.

If, following the check in the checking step 205, the participant is authorized to terminate or stop the conference, however, then the conference rule server 111 sends a conference termination message or conference stop message 207 to the focus 105 and, when the conference is terminated, the focus deletes the conference rule file 108 (step 213). When the conference is stopped, which is explained in more detail below, the conference rule file 108 is not deleted, however.

Upon receiving the conference termination message 207 from the conference rule server 111, the focus 105, deletes the conference and sends appropriate SIP session termination messages 208, for example a respective SIP “BYE” message, to the mobile radio terminals 101, 102, 103 participating in the conference. Next, the conference resources and the C-URI are released again (step 209). If the reinterpretation described above is applied, i.e. the conference is stopped, then the C-URI is not released.

When the conference termination messages 208 have been received, the respective participation in the conference is also terminated for each mobile radio terminal 101, 102, 103. In this case, the release of the conference resources is illustrated by the blocks 210, block 211 and block 212.

As is likewise shown in “Conference rule file example 2”, an additional authorization data element <allow-modify-tl> is optionally provided.

This authorization data element determines which user is permitted to enter another user into the <terminate-list> data element and/or to remove another user from the <terminate-list>data element.

As “Conference rule file example 2” reveals, an appropriate authorization data element and hence an appropriate authorization rule is set for the participant “Alice”, i.e. “Alice” is permitted to authorize other users to terminate and/or stop the conference.

In this case too, one alternative refinement of the invention has provision for the conference generator, as described above, not to need to be entered for the <allow-modify-tl> data elements, but rather for just other users to be entered in this list who are intended to be authorized, in addition to the conference generator, to enter other users into the <terminate-list> and/or to delete, i.e. to remove, other users from the <terminate-list>. In this case, the conference generator is generally authorized to perform these actions.

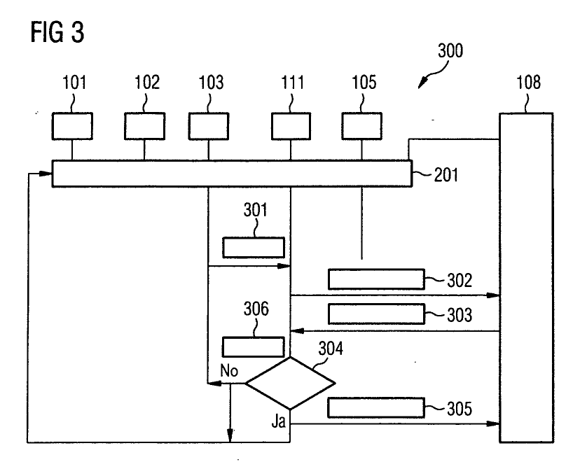

FIG. 3 uses a second message flow diagram 300 for the first exemplary embodiment of the invention to show the process of how termination rights are changed in the conference rule file 108.

In the figures, similar or identical elements have been provided with identical reference symbols.

In the case of an active conference 201, it is assumed that the third mobile radio terminal 103 generates a rights change request message 301 and transmits it to the conference rule server unit 111, which uses the read message 302 to check whether the <allow-modify-tl> data element for the requesting mobile radio terminal 103 is set to the value “true”, i.e. whether the request to change rights can be approved. In other words, a check is performed to determine whether the third mobile radio terminal 103 is authorized to make or request a change to the termination rights or stopping rights in the conference rule file 108. The reading of the corresponding information from the conference rule file 108 is shown symbolically by means of the <allow-modify-tl>read message 302 and the <allow-modify-tl> data element message 303.

If the third mobile radio terminal 103 or its user is authorized to make the requested change to the termination rights or stopping rights in the conference rule file 108 then the desired changed data are written to the <terminate-list> data element, symbolized in FIG. 3 by a <terminate-list> write message 305, and the conference is continued.

If the request is not justified, however, i.e. in other words the third mobile radio terminal 103 does not have the necessary access rights for changing the termination rights or stopping rights in the conference rule file 108, then the conference rule server 111 generates a corresponding negative acknowledgement message 306 and sends it to the third mobile radio terminal 103 and continues the conference unchanged.

In line with a second exemplary embodiment of the invention, provision is made to define two new actions within the <authorization-rules> elements in order to define a new conference rule data element (conference policy elements).

The first action in line with this second exemplary embodiment of the invention, called <terminate-handling> data element, indicates to the focus 105 how a request to terminate the conference needs to be handled. In line with this exemplary embodiment of the invention, the <terminate-handling> sub data element has at least two values, namely a first value “Allow” and a second value “Confirm”.

If the conference rule server 111 receives a request to terminate the conference, which is synonymous with the attempt to delete the conference rule file 108, then this request is performed if the <terminate-handling> data element contains the first value “Allow” for the corresponding user who is making the request. In this case, the conference rule server 111 will delete the conference rule file 108 and will instruct the focus 105 to terminate the conference. If the reinterpretation described above is applied then the conference is not terminated but rather is stopped.

In this case, the user will indicate this using the <conditions> sub data element of the rule element in the conference rule file 108 shown by way of example in “conference rule file example 3”.

If the <terminate-handling> data element contains the attribute “Confirm” then in line with this exemplary embodiment of the invention the conference generator or another user who has the right to terminate the conference, i.e. for example a user for whom the <terminate-handling> data element has the first value “Allow” set, is asked for appropriate authorization to terminate or stop the conference.

In this case, the conference is thus not terminated until the request has been authorized beforehand by an entity which is authorized to do so. It is also possible to link other conditions to the authorization to terminate or stop the conference, and hence to the value “Allow”.

Thus, by way of example, it is possible to request that a password and/or a PIN (Personal Identification Number) be given in addition:

```
<rule id=“3”>
  <conditions>
    <identity>
      <id>eckbertowitsch@example.com</id>
    </identity>
    </password>storno</password>
  </conditions>
  <actions>
    <allow-modify-tl>true</allow-modify-tl>
      <terminate-handling>allow</terminate-
  handling>
  </actions>
  <transformations/>
</rule>
<rule id=“4”>
  <conditions>
    <pin>211172</pin>
  </conditions>
  <actions>
    <terminate-handling>allow</terminate-
  handling>
  </actions>
  <transformations/>
</rule>
```

As example 3 shows, this exemplary embodiment of the invention optionally also has provision for a new authorization data element called <allow-modify-tl> which has the same authorization data element described in connection with the first exemplary embodiment of the invention. This authorization data element determines which user is permitted to set the attributes “Allow” and “Confirm” in the <terminate-handling> data element:
<allow-modify-tl>true</allow-modify-tl>

The text below shows an example of the conference rule file 108 based on the second exemplary embodiment of the invention.

Conference rule file example 3

```
<?xml version=“1.0” encoding=“UTF-8”?>
<conference xmlns=“urn:ietf:params:xml:ns:conference-policy”
xmlns:xsi=“http://www.w3.org/2001/XMLSchema-instance”>
  <settings>
    <conference-
  uri>sip:myconference@example.com</conference-uri>
    <max-participant-count>10</max-participant-count>
    <allow-sidebars>true</allow-sidebars>
  </settings>
  <info xml:lang=“en-us”>
    <subject>What's happening tonight</subject>
    <display-name>Party Goer's</display-name>
    <free-text>John and Peter will join the conference
  soon</free-text>
    <keywords>party nightclub beer</keywords>
    <host-info>
      <uri>sip:Alice@example.com</uri>
      <uri>tel:+3581234567</uri>
      <e-mail>mailto:Alice@example.com</e-mail>
      <web-
    page>http://www.example.com/users/Alice</web-page>
    </host-info>
  </info>
  <time>
    <occurrence>
      <mixing-start-time required-
    participant=“participant”>2004-12-17T09:30:00-
    05:00</mixing-start-time>
      <mixing-stop-time required-
    participant=“none”>2004-12-17T12:30:00-
    05:00</mixing-stop-time>
      <can-join-after>2001-12-17T09:25:00-05:00</can-
    join-after>
      <must-join-before>2004-12-17T12:00:00-
    05:00</must-join-before>
      <request-users required-
    participant=“none”>2001-12-17T09:30:00-
    05:00</request-users>
    </occurrence>
  </time>
  <authorization-rules>
    <rule id=“1”>
      <conditions>
        <identity>
          <domain>example.com</domain>
        </identity>
      </conditions>
      <actions>
        <allow-conference-state>true</allow-
      conference-state>
        <join-handling>allow</join-handling>
      </actions>
      <transformations/>
    </rule>
    <rule id=“2”>
      <conditions>
        <identity>
          <id>alice@example.com</id>
        </identity>
      </conditions>
      <actions>
        <allow-sidebar>true</allow-sidebar>
        <allow-modify-tl>true</allow-modify-tl>
        <terminate-handling>allow</terminate-
      handling>
      </actions>
      <transformations>
        <is-key-participant>true</is-key-
      participant>
      </transformations>
    </rule>
    <rule id=“3”>
      <conditions>
        <identity>
          <id>eckbertowitsch@example.com</id>
        </identity>
        </password>storno</password>
      </conditions>
      <actions>
        <allow-modify-tl>true</allow-modify-tl>
        <terminate-handling>allow</terminate-
      handling>
      </actions>
      <transformations/>
    </rule>
    <rule id=“4”>
      <conditions>
        <pin>211172</pin>
      </conditions>
      <actions>
        <terminate-handling>allow</terminate-
      handling>
      </actions>
      <transformations/>
    </rule>
  </authorization-rules>
  <dialout-list>
    <target uri=“sip:bob@example.com”/>
  </dialout-list>
  <refer-list >
    <target uri=“sip:sarah@example.com”/>
  </refer-list >
  <security-control>
    <security-mechanism tls=“false” s-mime=“true”/>
    <pin>13579</pin>
    <password>abcd1234</password>
  </security-control>
  <floor-policy>
    <floor floor-control=“fcp://example.com/floorabc”
  moderator-controlled=“false”>
      <media-streams>
        <audio media-id=“2”/>
      </media-streams>
      <algorithm>
        <fcfs/>
      </algorithm>
      <max-floor-users>1</max-floor-users>
    </floor>
  </floor-policy>
      <media-streams>
        <video media-id=“1”/>
        <audio media-id=“2”/>
      </media-streams>
    </conference>
```

The example above corresponds essentially to the example described in the prior art (Conference rule file example 1), with the changes envisaged in this exemplary embodiment in comparison with the prior art having been highlighted by bold text and underlining.

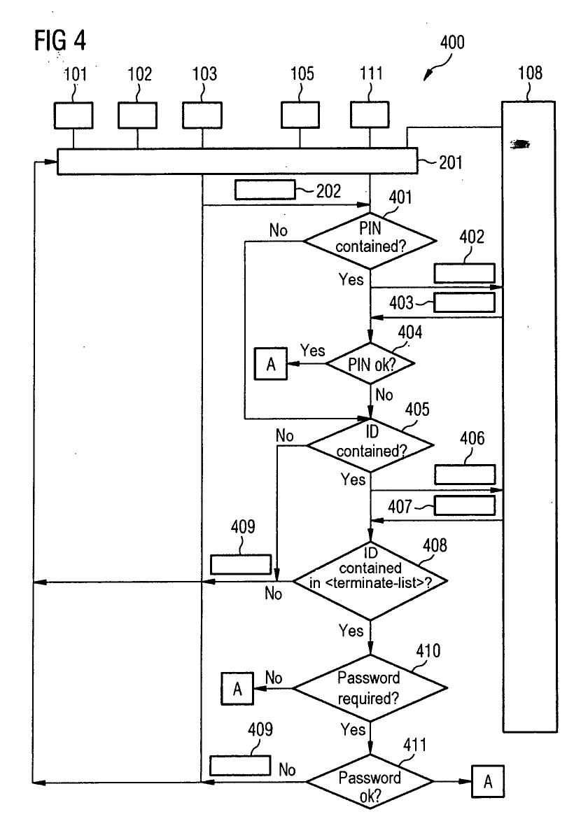

FIG. 4 uses a message flow diagram 400 to show the procedure for checking the authorization to terminate a conference based on the second exemplary embodiment of the invention.

The starting point is again a conference which is organized and controlled, activated and set up between the mobile radio terminals 101, 102, 103 by the focus 105 and the conference rule server 111, as symbolized by block 201.

Hence, a conference rule file 108 storing the individual conference-related rights and additional information is also generated and stored for the conference.

Following receipt of the termination request message 202 from the third mobile radio terminal 103, the conference rule server 111 first of all checks whether the termination request message 202 contains a personal identification number (PIN) (checking step 401).

If this is the case then in a second checking step 404 the conference rule server 111 checks, by reading stored PIN data elements from the conference rule file 108 (symbolized in FIG. 4 by means of a PIN data element request message 402 and a PIN data element message 403), whether the PIN contained in the termination request message 202 is identical to one of the PINs identified as authorized in the conference rule file 108.

If this is the case then the conference is terminated by virtue of the conference rule server 111 the focus in line with the conference termination message 207 the termination of the conference is communicated, and the focus 105 then transmits the conference termination messages 208 described above in connection with the first exemplary embodiment to the individual mobile radio terminals which are participating in the telecommunication conference. The conference resources are likewise released in the event of termination (step 209). In addition, the conference rule file 108 may be deleted by the conference rule server 111 (block 213). In other words, the steps denoted by the reference symbol A in FIG. 2 are performed.

However, if the termination request message 203 does not contain a PIN or if the PIN which the termination request message 202 contains does not match a PIN which is stored in the conference rule file 108 then the conference rule server 111 checks whether a sender identity indicator from the sender of the termination request message 202 is contained in the latter (checking step 405).

If this is the case then the request message 406 and 407 is used to read the rule element for this sender identity indicator, and a check is carried out to determine whether the <terminate-handling> rule element from the conference rule file 108 is set to “allow” (checking step 408).

If this is not the case or if the termination request message 102 does not contain any identification indicator for the participant sending the termination request message 202 then a negative acknowledgement message 409 is generated by the conference rule server 111 and may be transmitted to the sender of the termination request message 202, notifying said sender that the request could not be performed.

If the identification indicator does match an identification indicator in the <terminate-list> data element, however, then in a subsequent step a check is performed (checking step 410) to determine whether the corresponding participant still requires an additional authorization indicator, for example a password, and whether this password is contained in the termination request message 202 and matches the password indicator which the conference rule file 108 contains.

If no password is required but rather the participant has the right to have the requested termination performed even without an additional authorization indicator then the conference is terminated in the manner described above (step A).

However, if a password is required and if this password does not match the corresponding password stored in the conference rule file 108, which is checked in a further checking step (checking step 411), then the conference rule server 111 again generates a negative acknowledgement message 409 and transmits it to the corresponding participant, in this case to the third mobile radio terminal 103.

In all cases in which the termination could not be performed, the conference is continued unchanged.

If, as checked in checking step 411, the password is in order, however, i.e. if the password indicated in the termination request message 202 matches the corresponding password associated with the respective participant in the conference rule file 108 then the conference is again terminated in the manner described above (steps A).

In a corresponding procedure, it is also possible to make a rights change in the conference rule file in line with the second exemplary embodiment of the invention.

Example 3 above shows the conference policy document extended in line with this exemplary embodiment of the invention, i.e. the conference rule file 108 based on the third exemplary embodiment of the invention.

The rule element of “Alice” has been extended in this case. In general, a rule element can indicate a plurality of actions, but it is also possible to define a new element for each action, as described in H. Khartabil et al., for example.

In line with this exemplary embodiment of the invention, the action
<allow-modify-tl>true</allow-modify-tl>

has now again been used to provide the participant “Alice” with the right to create a rule and hence to store it in the conference rule file 108, in which the <terminate-handling> sub data element is set, using the conference rule server 111. The participant “Alice” can thus provide another user with the right to terminate a conference.

At the same time, the participant “Alice” is authorized by means of
<terminate-handling>allow</terminate-handling>

to terminate or stop the conference.

In this exemplary embodiment, the users specified by means of the SIP-URI “eckbertowitsch@example.com” (rule ID=“3”) are assigned the same rights as the participant “Alice”:

```
<rule id=“3”>
  <conditions>
    <identity>
      <id>eckbertowitsch@example.com</id>
    </identity>
    </password>storno</password>
  </conditions>
  <actions>
    <allow-modify-tl>true</allow-modify-tl>
    <terminate-handling>allow</terminate-
  handling>
  </actions>
  <transformations/>
</rule>
```

However, this user must additionally authorize himself using the password “storno”, as described above in connection with the message flow diagram 400 in FIG. 4, for example.

In line with rule 4 in “example 3” above in the conference rule file 108 (Rule ID=“4”), all users who authorize themselves using the PIN “211172” are permitted to terminate the conference:

```
<rule id=“4”>
  <conditions>
    <pin>211172</pin>
  </conditions>
  <actions>
    <terminate-handling>allow</terminate-
  handling>
  </actions>
  <transformations/>
</rule>
```

In alternative embodiments of the invention, provision is made for the methods described above to be carried out in combination with one another.

In addition, other alternative refinements of the invention have provision for the methods described above to be changed such that it is not stipulated in every case who is permitted to terminate the conference.

In this case, provision is made for an additional subdivision “Termination/Stop” or reinterpretation also to be provided.

If the conference is a “bounded conference” then provision may be made for the elements described above to be used to stipulate who is permitted to stop the current conference event (in contrast to the termination described above).

This is a development of the methods described above.

It should be noted that a basic distinction can be drawn between a bounded conference and an unbounded conference.

A bounded conference exists for a prescribed period and also includes weekly conferences, for example. Once the end of a bounded conference has been reached, all the participants are removed from the conference and all the SIP sessions or dialogues associated with the participants which relate to this conference are terminated, as described in H. Khartabil et al. The conference per se and hence also the conference policy, i.e. the conference rule, is maintained, however, i.e. the conference is not terminated. This case can also be referred to as stopping the conference.

If a conference is terminated then additionally the conference of the entity, i.e. the focus and, inter alia, the conference rule file 108, is terminated or deleted and the conference address, the C-URI, is released again.

An indication, which is separate for each conference event (a conference event is defined by-the <occurrence> sub data elements, which contain the starting time and the ending time of the conference, inter alia), of participants who are permitted to terminate and stop the corresponding conference event before it “expires” is given in line with the invention by a reference on or within the <occurrence> sub data element of the <time> data element in the conference rule file 108.

The above-described authorization data elements based on the exemplary embodiments of the invention are in this case provided with a further index which uniquely specifies the conference event to which this authorization data element relates. This is done using a reference, for example.

In line with the second exemplary embodiment, for example in the following manner:
<allow-modify-tl conference-event=“2”>
   and
<terminate-handling conference-event=“2”>allow</terminate-handling>,

which indicates that these rights relate to the second <occurrence> sub data element.

In this way, a user can be authorized to terminate the conference within a particular conference event, whereas he sometimes does not have this right within another conference event. In this way, it is a very simple matter to signal or perform the stopping of part of a telecommunication conference.

In line with the first exemplary embodiment of the invention, there are therefore a plurality of lists in an alternative embodiment of the invention, for example <terminate-list conference-event=“2”>, which show users who are permitted to terminate this corresponding conference event. In this case, in line with the first exemplary embodiment, there are therefore a plurality of <terminate-list> data elements in the conference rule file 108. These are distinguished by the “conference-event” attribute.

In one alternative refinement of the invention, however, each <occurrence> sub data element may also contain a separate <terminate-list> data element. In this case, the respective <terminate-list> data element does not need to contain a “conference-event” attribute.

However, the authorization data element should contain the index described above in this case too.

In one alternative refinement of the invention or in addition to the refinements of the invention which have been described above, provision is made for indication, possibly in addition to the indication of who is permitted to terminate a conference, of what events are to be taken as a basis for terminating the conference.

This is desirable in order to implement preset criteria for conference termination.

3rd Generation Partnership Project, Technical Specification Group Core Network, Conferencing Using the IP Multimedia (IM) Core Network (CN) Subsystem, Stage 3 (Release 6), 3GPP TS 24.147 V6.0.0, September 2004, and A. Johnston et al. have described such preset criteria according to which the conference is to be terminated when the generator of the conference has prompted this or the last participant has left the conference.

In line with the third exemplary embodiment of the invention, these preset criteria or else other criteria for conference termination are shown in the conference rule file 108 and can be altered using the CPCP in similar fashion to the termination rights, as have been described in the first exemplary embodiment of the invention or in the second exemplary embodiment of the invention.

To implement this exemplary embodiment of the invention, a user is assigned a specific attribute <is-essential-participant>. This assignment is made in line with H. Khartabil et al. using the <transformation> sub data element of an authorization rule. In this case, the user addressed using the <conditions> sub data element is assigned the attribute or right which is indicated in <transformation> sub data element. By way of example, in “Conference rule file example 1” the participant “Alice”, who is referenced by means of her SIP-URI “alice@example.com”, is assigned the attribute <is-key-participant>.

To allow the requirement formulated above, this exemplary embodiment of the invention involves introducing the additional attribute <is-essential-participant>. If appropriate, this too may involve reuse of the attribute <is-key-participant> in line with the invention, with said attribute accordingly being interpreted in line with the invention by the conference rule server unit 111.

In line with this exemplary embodiment of the invention, the conference is terminated if it is an unbounded conference, or a bounded conference is stopped, when any user who has this associated attribute leaves the conference. “Conference rule file example 4” shows the exemplary conference policy document extended in line with the third exemplary embodiment, i.e. the conference rule file 108 based on the third exemplary embodiment of the invention:

Conference rule file example 4

```
<?xml version=“1.0” encoding=“UTF-8”?>
<conference xmlns=“urn:ietf:params:xml:ns:conference-policy”
xmlns:xsi=“http://www.w3.org/2001/XMLSchema-instance”>
  <settings>
    <conference-
  uri>sip:myconference@example.com</conference-uri>
    <max-participant-count>10</max-participant-count>
    <allow-sidebars>true</allow-sidebars>
  </settings>
  <info xml:lang=“en-us”>
    <subject>What's happening tonight</subject>
    <display-name>Party Goer's</display-name>
    <free-text>John and Peter will join the conference
  soon</free-text>
    <keywords>party nightclub beer</keywords>
    <host-info>
      <uri>sip:Alice@example.com</uri>
      <uri>tel:+3581234567</uri>
      <e-mail>mailto:Alice@example.com</e-mail>
      <web-
    page>http://www.example.com/users/Alice</web-page>
    </host-info>
  </info>
  <time>
    <occurrence>
      <mixing-start-time required-
    participant=“participant”>2004-12-17T09:30:00-
    05:00</mixing-start-time>
      <mixing-stop-time required-
    participant=“none”>2004-12-17T12:30:00-
    05:00</mixing-stop-time>
      <can-join-after>2001-12-17T09:25:00-05:00</can-
    join-after>
      <must-join-before>2004-12-17T12:00:00-
    05:00</must-join-before>
      <request-users required-
    participant=“none”>2001-12-17T09:30:00-
    05:00</request-users>
    </occurrence>
  </time>
  <authorization-rules>
    <rule id=“1”>
      <conditions>
        <identity>
          <domain>example.com</domain>
        </identity>
      </conditions>
      <actions>
        <allow-conference-state>true</allow-
      conference-state>
        <join-handling>allow</join-handling>
      </actions>
      <transformations/>
    </rule>
    <rule id=“2”>
      <conditions>
        <identity>
          <id>alice@example.com</id>
        </identity>
      </conditions>
      <actions>
        <allow-sidebar>true</allow-sidebar>
      </actions>
      <transformations>
        <is-key-participant>true</is-key-
      participant>
        <is-essential-participant>true</is-
      essential-participant>
      </transformations>
    </rule>
  </authorization-rules>
  <dialout-list>
    <target uri=“sip:bob@example.com”/>
  </dialout-list>
  <refer-list >
    <target uri=“sip:sarah@example.com”/>
  </refer-list >
  <security-control>
    <security-mechanism tls=“false” s-mime=“true”/>
    <pin>13579</pin>
    <password>abcd1234</password>
  </security-control>
  <floor-policy>
    <floor floor-control=“fcp://example.com/floorabc”
  moderator-controlled=“false”>
      <media-streams>
        <audio media-id=“2”/>
      </media-streams>
      <algorithm>
        <fcfs/>
      </algorithm>
      <max-floor-users>1</max-floor-users>
    </floor>
  </floor-policy>
  <media-streams>
    <video media-id=“1”/>
    <audio media-id=“2”/>
  </media-streams>
</conference>
```

In this case, the participant “Alice” is indicated both as <is-key-participant> and as <is-essential-participant>:

```
<transformations>
  <is-key-participant>true</is-key-
participant>
  <is-essential-participant>true</is-
essential-participant>
</transformations>
```

When the participant “Alice” leaves the conference, the conference is terminated in line with this exemplary embodiment of the invention.

On the other hand, the conference may also be terminated in line with this exemplary embodiment of the invention as soon as this attribute is not associated with at least one active member, i.e. an active participant in the conference, i.e. the last user with whom this attribute is associated has left the conference. In this way, it is possible to implement both of the aforementioned preset criteria for conference termination.

In line with a fourth exemplary embodiment of the invention, an additional and important definition regarding what event is to be taken as a basis for terminating a conference is provided by means of the definition of a further data element within the conference rules.

In line with this exemplary embodiment of the invention, this data element is denoted by <terminate-event>. In line with this exemplary embodiment of the invention, this data element may contain a list of users who are indicated by means of their SIP-URI, for example.

Alternatively, the <terminate-event> data element may contain the attribute “condition”, which can assume the values “is-key-participant” and “is-essential-participant” or “participant” (without limiting the general validity). In addition, a time or a period may also be indicated as “condition” attribute. Once this time has been reached or the period has elapsed, the conference is terminated. In this case too, a reinterpretation may be made again, which means that the conference is not terminated but rather stopped.

When a user indicated by the <terminate-event> leaves the conference, the conference is terminated in line with this exemplary embodiment of the invention. In line with the exemplary embodiment indicated in “Conference rule file example 5”, the conference is a bounded conference, since the sub data element <mixing-stop-time> is contained within the <occurrence> sub data element of the <time> data element:

Conference rule file example 5

```
<?xml version=“1.0” encoding=“UTF-8”?>
<conference xmlns=“urn:ietf:params:xml:ns:conference-policy”
xmlns:xsi=“http://www.w3.org/2001/XMLSchema-instance”>
    <settings>
        <conference-
    uri>sip:myconference@example.com</conference-uri>
        <max-participant-count>10</max-participant-count>
        <allow-sidebars>true</allow-sidebars>
    </settings>
    <info xml:lang=“en-us”>
        <subject>What's happening tonight</subject>
        <display-name>Party Goer's</display-name>
        <free-text>John and Peter will join the conference
    soon</free-text>
        <keywords>party nightclub beer</keywords>
        <host-info>
            <uri>sip:Alice@example.com</uri>
            <uri>tel:+3581234567</uri>
            <e-mail>mailto:Alice@example.com</e-mail>
            <web-
        page>http://www.example.com/users/Alice</web-page>
        </host-info>
    </info>
    <time>
        <occurrence>
            <mixing-start-time required-
        participant=“participant”>2004-12-17T09:30:00-
        05:00</mixing-start-time>
            <mixing-stop-time required-
        participant=“none”>2004-12-17T12:30:00-
        05:00</mixing-stop-time>
            <can-join-after>2001-12-17T09:25:00-05:00</can-
        join-after>
            <must-join-before>2004-12-17T12:00:00-
        05:00</must-join-before>
            <request-users required-
        participant=“none”>2001-12-17T09:30:00-
        05:00</request-users>
        </occurrence>
    </time>
    <authorization-rules>
        <rule id=“1”>
            <conditions>
                <identity>
                    <domain>example.com</domain>
                </identity>
            </conditions>
            <actions>
                <allow-conference-state>true</allow-
            conference-state>
                <join-handling>allow</join-handling>
            </actions>
            <transformations/>
        </rule>
        <rule id=“2”>
            <conditions>
                <identity>
                    <id>alice@example.com</id>
                </identity>
            </conditions>
            <actions>
                <allow-sidebar>true</allow-sidebar>
            </actions>
            <transformations>
                <is-key-participant>true</is-key-
            participant>
                <is-essential-participant>true</is-
            essential-participant>
            </transformations>
        </rule>
    </authorization-rules>
    <terminate-event condition=”is-essential-participant”>
        <target uri=“sip:bob@example.com”/>
    </terminate-event>
    <dialout-list>
        <target uri=“sip:bob@example.com”/>
    </dialout-list>
    <refer-list >
        <target uri=“sip:sarah@example.com”/>
    </refer-list >
    <security-control>
        <security-mechanism tls=“false” s-mime=“true”/>
        <pin>13579</pin>
        <password>abcd1234</password>
    </security-control>
    <floor-policy>
        <floor floor-control=“fcp://example.com/floorabc”
    moderator-controlled=“false”>
            <media-streams>
                <audio media-id=“2”/>
            </media-streams>
            <algorithm>
                <fcfs/>
            </algorithm>
            <max-floor-users>1</max-floor-users>
        </floor>
    </floor-policy>
    <media-streams>
        <video media-id=“1”/>
        <audio media-id=“2”/>
    </media-streams>
</conference>
```

In line with this exemplary embodiment of the invention, the conference is thus terminated as soon as the participant “Bob”, specified by means of his SIP-URI, or one of the sometimes several essential conference participants leaves the conference:
<terminate-event condition=“is-essential-participant”><target uri=“sip:bob@example.com”/></terminate-event>

The value “participant” for the attribute “condition” states that the conference needs to be terminated when the last participant has left the conference.

As “example 5” has shown, the <terminate-event> may be a separate element in the conference rule file 108. In this case, it makes sense for this element to be applied and evaluated only during the last defined conference event if the conference can be associated with the class of bounded conferences. Otherwise, the conference would be terminated even though there are still further conference events defined but these have not yet taken place.

In one alternative embodiment, provision is therefore made for the <terminate-event> element to be introduced within the last existing <occurrence> sub data element. In this case, the <terminate-event> sub data element can be applied only in the last conference event. In addition, one alternative refinement of the invention provides for the <terminate-event> sub data element to be introduced outside of each <occurrence> sub data element, but within the <time> data element.

The text below illustrates a further example of the conference rule file 108 based on the fourth exemplary embodiment of the invention:

Conference rule file example 6

```
<?xml version=“1.0” encoding=“UTF-8”?>
<conference xmlns=“urn:ietf:params:xml:ns:conference-policy”
xmlns:xsi=“http://www.w3.org/2001/XMLSchema-instance”>
    <settings>
        <conference-
    uri>sip:myconference@example.com</conference-uri>
        <max-participant-count>10</max-participant-count>
        <allow-sidebars>true</allow-sidebars>
    </settings>
    <info xml:lang=“en-us”>
        <subject>What's happening tonight</subject>
        <display-name>Party Goer's</display-name>
        <free-text>John and Peter will join the conference
    soon</free-text>
        <keywords>party nightclub beer</keywords>
        <host-info>
            <uri>sip:Alice@example.com</uri>
            <uri>tel:+3581234567</uri>
            <e-mail>mailto:Alice@example.com</e-mail>
            <web-
        page>http://www.example.com/users/Alice</web-page>
        </host-info>
    </info>
    <time>
        <occurrence>
            <mixing-start-time required-
        participant=“participant”>2004-12-17T09:30:00-
        05:00</mixing-start-time>
            <mixing-stop-time required-
        participant=“none”>2004-12-17T12:30:00-
        05:00</mixing-stop-time>
            <can-join-after>2001-12-17T09:25:00-05:00</can-
        join-after>
            <must-join-before>2004-12-17T12:00:00-
        05:00</must-join-before>
            <request-users required-
        participant=“none”>2001-12-17T09:30:00-
        05:00</request-users>
        </occurrence>
        <terminate-time>2004-12-17T12:10:00-
    05:00</terminate-time>
    </time>
    <authorization-rules>
        <rule id=“1”>
            <conditions>
                <identity>
                    <domain>example.com</domain>
                </identity>
            </conditions>
            <actions>
                <allow-conference-state>true</allow-
            conference-state>
                <join-handling>allow</join-handling>
            </actions>
            <transformations/>
        </rule>
        <rule id=“2”>
            <conditions>
                <identity>
                    <id>alice@example.com</id>
                </identity>
            </conditions>
            <actions>
                <allow-sidebar>true</allow-sidebar>
            </actions>
            <transformations>
                is-key-participant>true</is-key-
            participant>
            </transformations>
        </rule>
    </authorization-rules>
    <dialout-list>
        <target uri=“sip:bob@example.com”/>
    </dialout-list>
    <refer-list >
        <target uri=“sip:sarah@example.com”/>
    </refer-list >
    <security-control>
        <security-mechanism tls=“false” s-mime=“true”/>
        <pin>13579</pin>
        <password>abcd1234</password>
    </security-control>
    <floor-policy>
        <floor floor-control=“fcp://example.com/floorabc”
    moderator-controlled=“false”>
            <media-streams>
                <audio media-id=“2”/>
            </media-streams>
            <algorithm>
                <fcfs/>
            </algorithm>
            <max-floor-users>1</max-floor-users>
        </floor>
    </floor-policy>
    <media-streams>
        <video media-id=“1”/>
        <audio media-id=“2”/>
    </media-streams>
</conference>
```

Besides the indication of what event is intended to trigger termination, one alternative refinement of the invention has provision for a time to be indicated at which the conference needs to be terminated. In this exemplary embodiment, this is not effected as a parameter of the “condition” attribute of the <terminate-event> data element, but rather as a separate data element. If three different conference events have been defined for a conference, for example, i.e. the conference rule file 108 contains three <occurrence> data elements, then on the basis of the prior art the conference would need to be terminated manually by sending an HTTP Delete message.

However, if a piece of information which has already been stored in the conference rule file 108 in line with this exemplary embodiment of the invention, for example
<terminate-time>2004-12-17T12:10:00-05:00</terminate-time>,

means that it is already a certainty in advance that the conference subsequently needs to be terminated then it is advantageous to provide ways of doing this within the conference rule.

In line with this exemplary embodiment of the invention, a new <terminate-time> sub data element is introduced for this purpose (see example 6 above), which indicates at what time the conference is to be terminated. In line with this exemplary embodiment of the invention, the conference event is stopped at 12 o'clock and is terminated at 12:10 using the parameter provided in line with this exemplary embodiment of the invention. In this case, as shown here, the <terminate-time> data element can be set in the <time> data element. There is also provision for and the possibility of other alternative variants, however. Preferably, the <terminate-time> data element needs to be set at a time which comes after the time at which the last existing conference event starts.

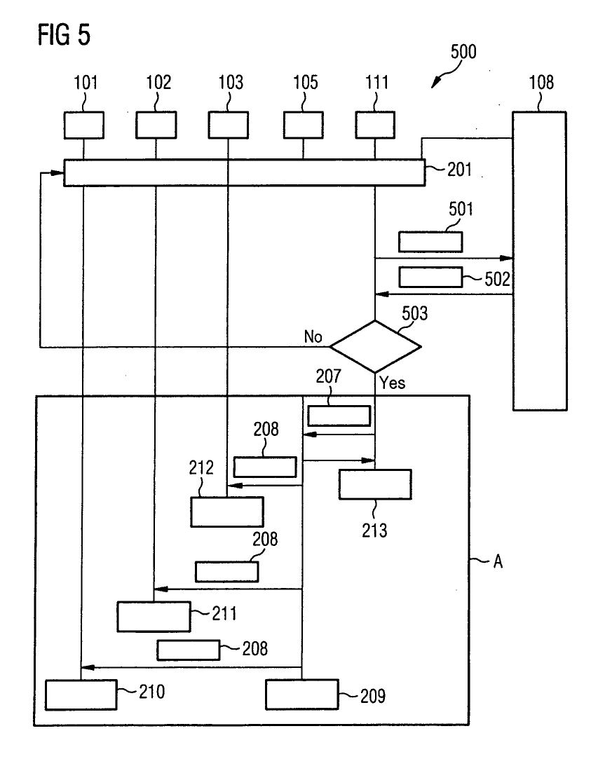

In a simplified illustration, FIG. 5 uses a message flow diagram 500 to show the termination of a conference when a prescribed event occurs, such as is contained in the conference rule file 108. The conference rule server 111 reads the appropriate data elements which define the termination events in the conference rule file 108 once, alternatively periodically at prescribed intervals of time, or continuously (shown symbolically by means of a read request message 501). For the termination events 502 which are read, the conference rule server 111 checks (checking step 503) whether the event or events has/have occurred.

If this is the case then the conference is terminated in the manner described above. Alternatively, the focus 105 may also perform the event check described.

If this is not the case then the conference is continued unchanged.

In summary, the following aspects of the invention should be mentioned:

1. The conference rule file is extended by the indication of which users are authorized to terminate a conference. Various solutions are described for this:
definition of a new element within the conference rule file which regulates who is permitted to terminate the conference;
definition of a new authorization rule to indicate which user is permitted to allocate rights for terminating the conference;
definition of a new action within the conference rules which introduces an at least two-level right for terminating a conference; and
introduction of a new transformation or inventive use of an already existing transformation in order to grant a user the right to terminate a conference.

2. The conference rule file is extended by an indication of what events are intended to be taken as a basis for terminating a conference. Various solutions are described for this:
definition of a new element listing events within the conference rule. If one of these events occurs, the conference is terminated;
as a special case, provision is made for a new element showing users to be defined within the conference rule file. If one of these users shown leaves the conference, the conference is terminated;
use of attributes within this list.

3. The conference rule file is extended by the indication of a time or a period which, when reached, is intended to involve the conference being terminated.

What is claimed is:

1. A method for the computer-aided management of a telecommunication conference using a telecommunication conference server device which provides at least one telecommunication conference between a plurality of participants, where the telecommunication conference server device has access to an electronic telecommunication conference rule file, with the telecommunication conference rule file containing, for the telecommunication conference provided, information which can be used to ascertain that participant or those participants who is/are permitted to stop or terminate the telecommunication conference or to stop part of the telecommunication conference, the method comprising the steps of:
the telecommunication conference server device receiving a request from a participant participating in the telecommunication conference to stop or terminate the telecommunication conference or to stop part of the telecommunication conference;
the telecommunication conference server device using the telecommunication conference rule file to check whether the participant is authorized to stop or terminate the telecommunication conference or to stop part of the telecommunication conference;
if the participant is not authorized to stop or terminate the telecommunication conference or to stop the part of the telecommunication conference then the telecommunication conference server device continuing the telecommunication conference; and
if the participant is authorized to stop or terminate the telecommunication conference or to stop the part of the telecommunication conference then the telecommunication conference server device stopping or terminating the telecommunication conference or stopping the part of the telecommunication conference.

2. The method as claimed in claim 1, wherein the telecommunication conference rule file can be altered by one or more participants.

3. The method as claimed in claim 2, wherein the telecommunication conference rule file contains information regarding which participant or which participants is/are permitted to alter the telecommunication conference rule file.

4. The method as claimed in claim 3, wherein the telecommunication conference rule file contains information regarding which participant or which participants is/are permitted to alter, in the telecommunication conference rule file, the information which can be used to ascertain which participant or which participants is/are permitted to stop or terminate the telecommunication conference or to stop the part of the telecommunication conference.

5. The method as claimed in claim 1, wherein the information regarding which participant is authorized to stop or terminate the telecommunication conference or to stop the part of the telecommunication conference is stored in the telecommunication conference rule file in the form of one or more data elements.

6. The method as claimed in claim 1, wherein the information regarding which participant is authorized to stop or terminate the telecommunication conference or to stop the part of the telecommunication conference is stored in the telecommunication conference rule file in the form of one or more action data elements.

7. The method as claimed in claim 1, wherein the communication taking place between the participants and the telecommunication conference server device is at least partly based on the Session Initiation Protocol.

8. The method as claimed in claim 1, wherein the communication taking place between the participants and the telecommunication conference server device is at least partly based on the Conference Policy Control Protocol.

9. The method as claimed in claim 1, wherein the telecommunication conference provided is a multimedia telecommunication conference in which the subscribers are provided with a plurality of different media data streams.

10. The method as claimed in claim 1, wherein the telecommunication conference server device is clearly identified by means of an SIP Unique Resource Identifier.

11. The method as claimed in claim 1, wherein the telecommunication conference rule file is stored in XML format.

12. The method as claimed in claim 1, wherein the telecommunication conference rule file is accessed on the basis of the Hypertext Transfer Protocol.

13. The method as claimed in claim 1, wherein the participants in the telecommunication conference transmit and/or receive data on the basis of a mobile radio communication protocol.

14. The method as claimed in claim 13, wherein the participants in the telecommunication conference transmit and/or receive data on the basis of a 3GPP mobile radio communication protocol.

15. The method as claimed in claim 14, wherein the participants in the telecommunication conference transmit and/or receive data on the basis of a UMTS mobile radio communication protocol.

16. A method for the computer-aided management of a telecommunication conference using a telecommunication conference server device which provides at least one telecommunication conference between a plurality of participants, where the telecommunication conference server device has access to an electronic telecommunication conference rule file, with the telecommunication conference rule file containing, for the telecommunication conference provided, information which can be used to ascertain what event or what events is/are taken as a basis for stopping or terminating the telecommunication conference or for stopping a part of the telecommunication conference, the method comprising the steps of:
the telecommunication conference server device or the telecommunication conference rule server using the telecommunication conference rule file to check whether the event or the events has/have occurred;
if the event or the events has/have not occurred then the telecommunication conference server device continuing the telecommunication conference or the part of the telecommunication conference; and
if the event or the events has/have occurred then the telecommunication conference server device stopping or terminating the telecommunication conference or stopping the part of the telecommunication conference.

17. The method as claimed in claim 16, wherein the telecommunication conference rule file can be altered by one or more participants.

18. The method as claimed in claim 17, wherein the telecommunication conference rule file contains information regarding which participant or which participants is/are permitted to alter the telecommunication conference rule file.

19. The method as claimed in claim 18, wherein the telecommunication conference rule file contains information regarding which participant or which participants is/are permitted to alter, in the telecommunication conference rule file, the information which can be used to ascertain what event or what events is/are taken as a basis for stopping or terminating the telecommunication conference or for stopping the part of the telecommunication conference.

20. The method as claimed in claim 16, wherein the event is selected from the group consisting of:
one or more participant(s) in the telecommunication conference who is/are indicated in the telecommunication conference rule file leaves or leave the telecommunication conference;
a time indicated in the telecommunication conference rule file is reached; and
the telecommunication conference has already existed for a maximum period indicated in the telecommunication conference rule file.

21. The method as claimed in claim 16, wherein the communication taking place between the participants and the telecommunication conference server device is at least partly based on the Session Initiation Protocol.

22. The method as claimed in claim 16, wherein the communication taking place between the participants and the telecommunication conference server device is at least partly based on the Conference Policy Control Protocol.

23. The method as claimed in claim 16, wherein the telecommunication conference provided is a multimedia telecommunication conference in which the subscribers are provided with a plurality of different media data streams.

24. The method as claimed in claim 16, wherein the telecommunication conference server device is clearly identified by means of an SIP Unique Resource Identifier.

25. The method as claimed in claim 16, wherein the telecommunication conference rule file is stored in XML format.

26. The method as claimed in claim 16, wherein the telecommunication conference rule file is accessed on the basis of the Hypertext Transfer Protocol.

27. The method as claimed in claim 16, wherein the participants in the telecommunication conference transmit and/or receive data on the basis of a mobile radio communication protocol.

28. The method as claimed in claim 27, wherein the participants in the telecommunication conference transmit and/or receive data on the basis of a 3GPP mobile radio communication protocol.

29. The method as claimed in claim 28, wherein the participants in the telecommunication conference transmit and/or receive data on the basis of a UMTS mobile radio communication protocol.

30. A telecommunication conference server device, set up to provide at least one telecommunication conference between a plurality of participants, comprising:
access to an electronic telecommunication conference rule file containing, for the telecommunication conference provided, information used to ascertain which participant or which participants is/are permitted to stop or terminate the telecommunication conference or to stop the part of the telecommunication conference;
a reception unit for receiving a request from a participant participating in the telecommunication conference to stop or terminate the telecommunication conference or to stop the part of the telecommunication conference;
an authorization checking unit for checking, using the telecommunication conference rule file, whether the participant is authorized to stop or terminate the telecommunication conference or to stop the part of the telecommunication conference; and
a telecommunication conference termination unit which is set up to stop or terminate the telecommunication conference or to stop the part of the telecommunication conference if the participant is authorized to stop or terminate the telecommunication conference or to stop the part of the telecommunication conference.

31. A telecommunication conference server device, set up to provide at least one telecommunication conference between a plurality of participants, comprising:
access to an electronic telecommunication conference rule file containing, for the telecommunication conference provided, information which can be used to ascertain what event or what events is/are taken as a basis for stopping or terminating the telecommunication conference or for stopping a part of the telecommunication conference;
an event checking unit for checking, using the telecommunication conference rule file, whether the event or the events has/have occurred; and
a telecommunication conference termination unit which is set up to stop or terminate the telecommunication conference or to stop the part of the telecommunication conference if the event or the events has/have occurred.
